(19) United States
(12) Patent Application Publication
(10) Pub. No.: US 2010/0207995 A1
(43) Pub. Date: Aug. 19, 2010

(54) Recording Head and Image Forming Apparatus

(76) Inventor: Sho Onozawa, Kanagawa (JP)

Correspondence Address: FISH & RICHARDSON P.C., PO BOX 1022, MINNEAPOLIS, MN, 55440-1022, US

(21) Appl. No.: 12/707,539

(22) Filed: Feb. 17, 2010

(30) Foreign Application Priority Data
Feb. 18, 2009 (JP) 2009035394

(51) Int. Cl. B41J 2/155; B41J 2/175

(52) U.S. Cl. 347/42; 347/85

(57) ABSTRACT

There is provided a recording head including: a first common path; a second common path; plural first pressure chambers; plural first driving sections; plural second pressure chambers; and plural second driving sections, wherein the first common path and the second common path are formed with the same dimensions, and the second pressure chamber that is driven by the second driving section is the second pressure chamber positioned where the distance thereto from the first pressure chamber driven by the first driving section toward the first opening and through the second common path is the same as the distance thereto from the first pressure chamber toward the second opening and through the second common path, and a pressure wave is generated that is of opposite phase to that of the pressure wave generated from the first pressure chamber.

### CROSS-REFERENCE TO RELATED APPLICATION

This application claims priority under 35 USC 119 from Japanese Patent Application No. 2009-035394 filed on Feb. 18, 2009, the disclosure of which is incorporated by reference herein.

### BACKGROUND

1. Technical Field

The present invention relates to a recording head and an image forming apparatus.

2. Related Art

In a single-pass inkjet recording apparatus, since the desired image resolution must be realized when only passing a recording medium a single time, the number of nozzles of an inkjet recording head in the slow scanning direction necessarily become large. Due to this increase, the length of a common path storing a liquid (ink or the like) gets longer, lowering the resonance frequency of the liquid in the common path. When this resonance frequency is lowered to the vicinity of the ejection frequencies, the liquid droplets ejection characteristics between the nozzles are influenced by resonance in the common path, with so-called cross-talk becoming significant, potentially leading to a deterioration in the quality of images formed. The cross-talk referred to here is a phenomenon that disrupts ink ejection, as the ejection operation at a given nozzle interferes with the ink at another nozzle.

A configuration is described in Japanese Patent Application Laid-Open (JP-A) No. 2006-82394 in which an air chamber is provided at a position in the vicinity of a common path, and a thin plate, capable of resilient deformation, is employed between the common path and the air chamber so as to partition therebetween. The acoustic capacitance of the common path is thereby made larger, with the aim of ensuring sufficient acoustic capacitance to attenuate cross-talk.

However, in JP-A No. 2006-82394, since the thin plate capable of resilient deformation partitions between the common path and the air chamber, defects, such as breakage, readily occur in the thin plate, and there is the possibility of liquid leaks occurring. Furthermore, while the capacitance damper due to the thin plate is effective for high frequency components, it cannot be said to be effective for low frequency components, and so when the resonance frequency of the liquid within the common path is lowered to the vicinity of the ejection frequencies, it is difficult to suppress the influence of cross-talk due to low frequency resonance.

### SUMMARY

The present invention was made in consideration of the above circumstances and provides a recording head and an image forming apparatus that can suppress the influence of cross-talk due to low frequency resonance and can raise image quality.

A first aspect of the present invention provides a recording head including:

a first common path that stores a liquid;

a second common path that is disposed along a length direction of the first common path, with the liquid circulated between the first common path and the second common path through a first opening and a second opening formed respectively in the two ends of a divider plate that divides the second common path from the first common path;

plural first pressure chambers that are respectively in communication with plural first liquid supply paths connected to the first common path, with the first pressure chambers filled by the liquid supplied through the respective first liquid supply path from the first common path;

plural first driving sections that change pressure of the respective first pressure chambers, and eject liquid droplets from a nozzle communicating with the respective first pressure chamber toward a recording medium;

plural second pressure chambers that are respectively in communication with plural second liquid supply paths connected to the second common path, with the second pressure chambers filled by the liquid supplied through the respective second liquid supply path from the second common path;

plural second driving sections that change pressure of one or other of the second pressure chambers, and generate a pressure wave that attenuates a pressure wave from the first pressure chamber that was driven by the first driving section, propagating in the first common path and the second common path, the pressure wave not ejecting liquid droplets.

According to the first aspect of the present invention, plural first liquid supply paths that are respectively in communication with the plural first pressure chambers are connected to the first common path that stores the liquid, and the liquid in the first common path is supplied to the first pressure chambers through the respective plural first liquid supply paths. The second common path is provided along the length direction of the first common path, divided from the first common path with the divider plate, with the liquid circulated between the first common path and the second common path through a first opening and a second opening formed respectively in the two ends of the divider plate. The plural second liquid supply paths that are in communication with the respective plural second pressure chambers are connected to the second common path, with the second pressure chambers supplied with the liquid in the second common path through the respective plural second liquid supply paths. Furthermore, liquid droplets are ejected toward the recording medium from nozzles in communication with the first pressure chambers by changing the pressure in the first pressure chambers using the first driving sections. When this is performed, by changing the pressure of one or other of the second pressure chambers using the respective second driving section and generating a pressure wave, the pressure wave from the first pressure chamber that was driven by the first driving section, propagating in the first common path and the second common path, is attenuated by the pressure wave from the second pressure chamber.

According to such a configuration, since the overall common path through which the liquid circulates is lengthened by provision of the first common path and the second common path, lowering the resonance frequency of the liquid in the common path, the effective resonance frequency can be moved away from the ejection frequency band. Therefore, influence of cross-talk due to low frequency resonance can be suppressed. At the same time, since the overall common path in which the liquid circulates is longer, the influence of cross-talk can be effectively suppressed by viscosity attenuation. Furthermore, by changing the pressure of one or other of the second pressure chambers with the respective second driving section and generating a pressure wave, the pressure wave from the first pressure chamber that was driven by the first driving section, propagating in the first common path and the second common path, is attenuated, and the influence of cross-talk can be effectively suppressed.

A second aspect of the present invention provides the recording head of the first aspect, wherein:

the first common path and the second common path are formed with the same dimensions; and

the second pressure chamber that is driven by the second driving section is the second pressure chamber positioned where the distance thereto from the first pressure chamber driven by the first driving section toward the first opening and through the second common path is the same as the distance thereto from the first pressure chamber toward the second opening and through the second common path, and a pressure wave is generated that is of opposite phase to that of the pressure wave generated from the first pressure chamber.

According to the second aspect of the present invention, a pressure wave is generated that is of opposite phase to that of the pressure wave generated from the first pressure chamber by driving the second pressure chamber, positioned where the distance thereto from the first pressure chamber driven by the first driving section toward the first opening and through the second common path is the same as the distance thereto from the first pressure chamber toward the second opening and through the second common path, with the second driving section. By so doing, the pressure wave propagating in the first common path and the second common path from the first pressure chamber is attenuated by the pressure wave of opposite phase generated from the second pressure chamber. Consequently, the influence of cross-talk can be effectively suppressed.

A third aspect of the present invention provides the recording head of the first aspect, wherein:

the first common path and the second common path are formed with the same dimensions; and

the second pressure chamber that is driven by the second driving section is positioned symmetrically about a point with respect to the first pressure chamber that is driven by the first driving section, relative to a central position of the divider plate.

According to the third aspect of the present invention, by driving the second pressure chamber positioned symmetrically about a point with respect to the first pressure chamber that is driven by the first driving section, relative to the central position of the divider plate, with the second driving section, a pressure wave of opposite phase to the pressure wave generated from the first pressure chamber is generated. By so doing, the pressure wave propagating in the first common path and the second common path from the first pressure chamber is attenuated by the pressure wave of opposite phase generated from the second pressure chamber. Consequently, the influence of cross-talk can be effectively suppressed.

A fourth aspect of the present invention provides the recording head of the first aspect, wherein the second pressure chamber is not provided with a nozzle for ejecting liquid droplets.

According to the fourth aspect of the present invention, since the second pressure chamber is not provided with a nozzle for ejecting liquid droplets, ejection of liquid droplets onto the recording medium when the pressure of the second pressure chamber is changed by the second driving section can be prevented.

A fifth aspect of the present invention provides an image forming apparatus that forms an image by passing a recording medium through a position facing a recording head, the image forming apparatus including:

the recording head of the first aspect; and

a conveying section that conveys a recording medium to a position facing the recording head.

According to the fifth aspect of the present invention, the recording medium is conveyed to a position facing the recording head by the conveying section. Then the recording head forms an image by passing the recording medium past the position facing the recording head. When this is performed, since the overall common path storing the liquid is configured longer by provision of the first common path and the second common path, influence of cross-talk due to low frequency resonance is suppressed. Furthermore, by changing the pressure of one or other of the second pressure chambers by driving from the respective second driving section and generating a pressure wave, the pressure wave from the first pressure chamber that was driven by the first driving section, propagating in the first common path and the second common path, is attenuated, and the influence of cross-talk can be effectively suppressed. Consequently, occurrences of deterioration in image quality can be prevented or suppressed.

According to the present invention, the influence of cross-talk due to low frequency resonance can be suppressed, and image quality can be raised.

### BRIEF DESCRIPTION OF THE DRAWINGS

Exemplary embodiments of the present invention will be described in detail based on the following figures, wherein:

FIG. 1 is an overall configuration diagram showing a configuration of an image forming apparatus equipped with an inkjet line-head according to a first exemplary embodiment of the present invention;

FIG. 2 is a see-through perspective view showing a configuration of an inkjet line-head according to the first exemplary embodiment;

FIG. 3 is a schematic cross-section showing a cross-section along the length direction of an inkjet line-head according to the first exemplary embodiment;

FIG. 4A is a schematic plan view showing a configuration of a first common path of an inkjet line-head according to the first exemplary embodiment;

FIG. 4B is enlarged plan view diagram showing a portion of the configuration of the first common path;

FIG. 5 is a schematic cross-section showing a cross-section orthogonal to the length direction of an inkjet line-head according to the first exemplary embodiment;

FIG. 6A is an example of a pressure wave generated from a first pressure chamber by driving of a first driving section;

FIG. 6B is an example of a pressure wave of opposite phase generated from a second pressure chamber by driving of a second driving section; and

FIG. 7 is a schematic cross-section showing a cross-section along the length direction of an inkjet line-head according to a second exemplary embodiment.

### DETAILED DESCRIPTION

### First Exemplary Embodiment

Explanation will now be given of an image forming apparatus equipped with an inkjet line-head as a recording head according to a first exemplary embodiment of the present invention.

First, explanation will be given of the overall configuration of an image forming apparatus 10.

Image Forming Apparatus

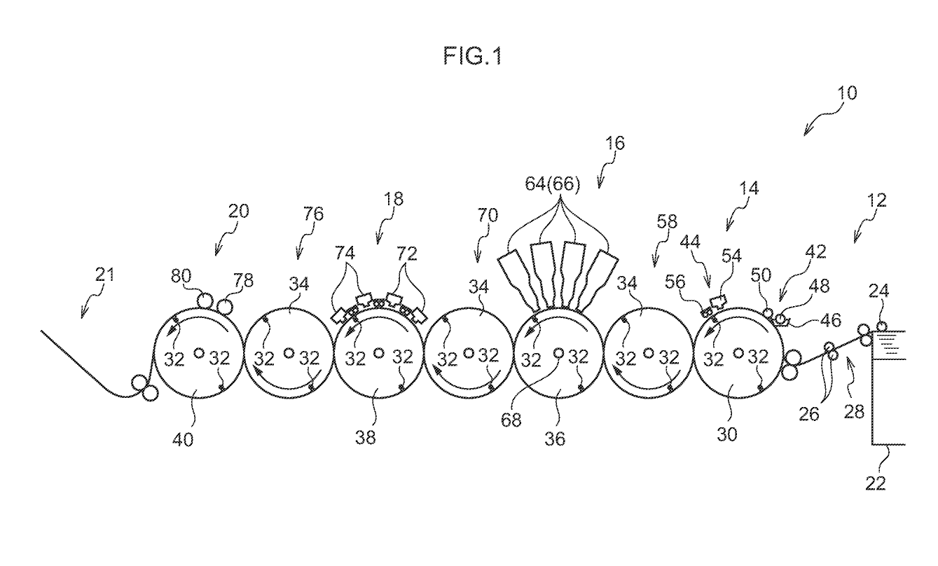

As shown in FIG. 1, the image forming apparatus 10 according to the present exemplary embodiment is provided, at the conveying direction upstream side of sheets of paper (referred to as “paper” below) serving as a recording medium, with a paper feed conveying section 12 that feeds and conveys paper. Provided at the downstream side of the paper feed conveying section 12 are, along the paper conveying direction: a processing liquid application section 14 that applies a processing liquid onto a recording face of the paper; an image forming section 16 that forms an image on the recording face of the paper; an ink drying section 18 that dries the image that has been formed on the recording face; an image fixing section 20 that fixes the dried image to the paper; and a discharge section 21 that discharges the paper to which the image has been fixed.

Explanation will now be given of each of the processing sections.

Paper Feed Conveying Section

In the paper feed conveying section 12 are provided a stacking section 22, in which paper is stacked, and, to the downstream side in the paper conveying direction (this is sometimes abbreviated below to “paper conveying direction”) of the stacking section 22, a feed section 24 that feeds out paper stacked in the stacking section 22, one sheet at a time. The paper fed out by the feed section 24 is conveyed toward the processing liquid application section 14 through a conveying section 28 configured by plural pairs of rollers 26.

Processing Liquid Application Section

A processing liquid application drum 30 is rotatably disposed in the processing liquid application section 14. Retaining members 32 are provided to the processing liquid application drum 30 for nipping the leading edge of the paper and retaining the paper. The paper is conveyed to the downstream side, with the paper in a retained state on the surface of the processing liquid application drum 30 due to the retaining members 32, by rotation of the processing liquid application drum 30.

Note that the retaining members 32 are also provided to an intermediate conveying drum 34, an image forming drum 36, an ink drying drum 38, and an image fixing drum 40 (described below) in a similar manner to provision to the processing liquid application drum 30. The paper is passed from a drum on the upstream side and received by a drum on the downstream side by use of the retaining members 32.

A processing liquid application device 42 and a processing liquid drying device 44 are disposed above the processing liquid application drum 30, around the circumferential direction of the processing liquid application drum 30. Processing liquid is applied to the recording face of the paper by the processing liquid application device 42, and this processing liquid is dried by the processing liquid drying device 44.

The processing liquid here reacts with ink, having the effect of aggregating colorants (pigments) and promoting separation of colorants (pigments) from their solvent medium. A reservoir section 46 is provided to the processing liquid application device 42, and processing liquid is stored in the reservoir section 46. A portion of a gravure roller 48 is steeped in the processing liquid.

A rubber roller 50 is disposed in pressing contact with the gravure roller 48, and the rubber roller 50 makes contact with the recording face (front face) side of the paper and applies processing liquid thereto. There is also a squeegee (not shown in the drawings) that makes contact with the gravure roller 48, and meters the processing liquid amount applied to the recording face of the paper.

Ideally the thickness of the processing liquid film is sufficiently smaller than the liquid droplets of the head ejected droplets. For example, when the amount of the ejected droplets is 2 pl, then the average diameter of the liquid droplets of the head ejected droplets is 15.6 μm, and if the thickness of the processing liquid film is thick then the ink dots do not make contact with the recording face of the paper, and float within the processing liquid. The processing liquid film thickness is preferably 3 μm or less, such that an impacting dot diameter of 30 μm or greater is obtained for a 2 pl ejected droplet amount.

However, in the processing liquid drying device 44, a heated air nozzle 54 and an infra-red heater 56 (referred to below as “IR heater 56”) are disposed in close proximity to the surface of the processing liquid application drum 30. The solvent medium in the processing liquid, such as water or the like, is evaporated by the heated air nozzle 54 and the IR heater 56, and a solid or thin film processing liquid layer is formed on the recording face side of the paper. By making the processing liquid into a thin layer by the processing liquid drying process, the dots of ink ejected droplets make contact with the paper surface in the image forming section 16, and the necessary dot size is obtained, reacting with the processing liquid formed in a thin layer, aggregating colorants, and the actions to immobilize the dots on the paper surface are readily obtained.

In this manner, the processing liquid is applied to the recording face in the processing liquid application section 14, and the dried paper is conveyed to an intermediate conveying section 58 provided between the processing liquid application section 14 and the image forming section 16.

Intermediate Conveying Section

In the intermediate conveying section 58, the intermediate conveying drum 34 is rotatably provided, the paper is retained on the surface of the intermediate conveying drum 34 by the retaining members 32 provided to the intermediate conveying drum 34, and the paper is conveyed toward the downstream side by rotation of the intermediate conveying drum 34.

Image Forming Section

In the image forming section 16, the image forming drum 36 is rotatably provided, the paper is retained on the surface of the image forming drum 36 by retaining members 32 provided to the image forming drum 36, and the paper is conveyed toward the downstream side by rotation of the image forming drum 36.

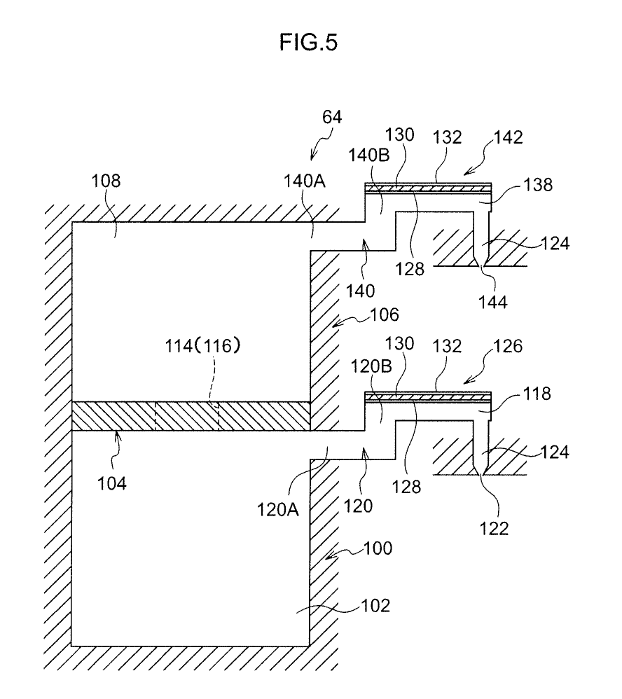

A head unit 66, configured with single-pass inkjet line-heads 64, is disposed above the image forming drum 36, in close proximity to the surface of the image forming drum 36. Inkjet line-heads 64, at least for the basic colors YMCK, are arrayed in the head unit 66 around the circumferential direction of the image forming drum 36, and images for each of the colors are formed on the processing liquid layer that was formed on the recording face of the paper in the processing liquid application section 14. The inkjet line-heads 64 each have a length corresponding to the maximum paper width applicable to the image forming apparatus 10, and plural nozzles 122 for ink ejection (see FIG. 5) are arrayed on the nozzle face of the inkjet line-heads 64, over a length that exceeds at least the length of one side of the maximum size of paper (the entire width of the image formable range).

The processing liquid possesses the ability to aggregate in the processing liquid colorant (pigments) and latex particles that were dispersed in the ink, and aggregated bodies are formed on the paper, without color-run or the like occurring. As an example of a reaction between the ink and the processing liquid, acid may be contained in the processing liquid, the pigment dispersion broken down by reducing the pH, and the pigment aggregated. Such a mechanism may be employed in order to avoid color bleeding, mixing of each of the colors between the inks, and ejected droplet interference due to liquid merging when ink droplets impact.

By performing droplet ejection synchronized to an encoder (not shown in the drawings), disposed on the image forming drum 36 and detecting rotation speed, the inkjet line-heads 64 are able to determine the impact position of droplets with high precision, and are also capable of reducing ejected droplet unevenness without being affected by vibrations of the image forming drum 36, the precision of a rotation axis 68, or the drum surface speed.

Note that the head unit 66 may be configured retractable from above the image forming drum 36, with the head unit 66 retracted from above the image forming drum 36 when maintenance operations, such as nozzle face cleaning of the inkjet line-heads 64, removal of congealed ink or the like, are executed.

The paper formed with an image on the recording face is conveyed by rotation of the image forming drum 36 toward an intermediate conveying unit 70 provided between the image forming section 16 and the ink drying section 18, however, since the configuration of the intermediate conveying unit 70 is substantially the same as that of the intermediate conveying section 58, explanation thereof will be omitted.

Ink Drying Section

The ink drying drum 38 (described later) is rotatably provided within the ink drying section 18, and plural heated air nozzles 72 and IR heaters 74 are provided above the ink drying drum 38, in close proximity to the surface of the ink drying section 18.

As an example, a pair of the IR heaters 74 are alternately arrayed parallel to one of the heated air nozzles 72, so as to be disposed one on the upstream side and one on the downstream side of the heated air nozzle 72. As an alternative to this, many of the IR heaters 74 may be disposed at the upstream side, with a lot of heat energy irradiated at the upstream side, raising the temperature of the water content, and many of the heated air nozzles 72 may be disposed at the downstream side to blow away the saturated water vapor.

Here the heated air nozzles 72 are disposed such that the angle of heated air that is blown onto the paper is inclined toward the trailing edge side of the paper. By so doing, the flow of heated air due to the heated air nozzle 72 can be concentrated in one direction, the paper is pressed toward the ink drying drum 38 side, and the state of the paper retained on the surface of the ink drying drum 38 can be maintained.

In the portion of the paper formed with the image, the solvent medium that has been separated by the action of colorant aggregation is dried by the warm air from the heated air nozzles 72 and the IR heaters 74, forming an image layer of a thin film.

While it differs depending on the conveying speed, usually the warm air temperature is set from 50° C. to 70° C., and the temperature of the IR heaters 74 is set from 200° C. to 600° C., so that the ink surface temperature is from 50° C. to 60° C. The evaporated solvent medium is exhausted with the air to outside of the image forming apparatus 10, however the air is recycled. The liquid in this air may be recovered by cooling with a cooler, a radiator, or the like.

The paper with dried image on the recording face thereof is conveyed by rotation of the ink drying drum 38 toward an intermediate conveying section 76, disposed between the ink drying section 18 and the image fixing section 20, however since the configuration of the intermediate conveying unit 76 is substantially the same as that of the intermediate conveying section 58, explanation thereof will be omitted.

Image Fixing Section

The image fixing drum 40 is rotatably provided in the image fixing section 20, and the image fixing section 20 has functionality for heating and pressing the latex particles in the thin-layered image layer that was formed on the ink drying drum 38, fusing the latex particles and immobilizing and fixing to the paper.

A heat roller 78 is disposed above the image fixing drum 40, in close proximity to the surface of the image fixing drum 40. The heat roller 78 incorporates a halogen lamp within a metal pipe of good heat conductivity, such as aluminum or the like, and heat energy is imparted by the heat roller 78 to raise the temperature of the latex to the Tg temperature or greater. By so doing, the latex particles fuse, and when fixing is performed by pressing into the undulations on the paper, it is possible to obtain glossiness by leveling the undulations of the image surface.

A fixing roller 80 is provided at the downstream side of the heat roller 78, with the fixing roller 80 disposed in a pressing state onto the surface of the image fixing drum 40 such that a nip force is obtained between the fixing roller 80 and the image fixing drum 40. Configuration is therefore made with at least one of the surface of the fixing roller 80 or the surface of the image fixing drum 40 having a resilient layer thereon, a configuration having a uniform nip width onto the paper.

The paper fixed with an image on the recording face by the above processes, is conveyed by rotation of the image fixing drum 40 to the side of the discharge section 21, provided at the downstream side of the image fixing section 20.

It should be noted that while explanation has been given in the present exemplary embodiment regarding the image fixing section 20, since it is sufficient for the image formed on the recording face to be dried and fixed by the ink drying section 18, the image fixing section 20 is not necessarily always included.

Explanation will now be given regarding the inkjet line-heads 64, serving as the recording heads according to the first exemplary embodiment of the present invention.

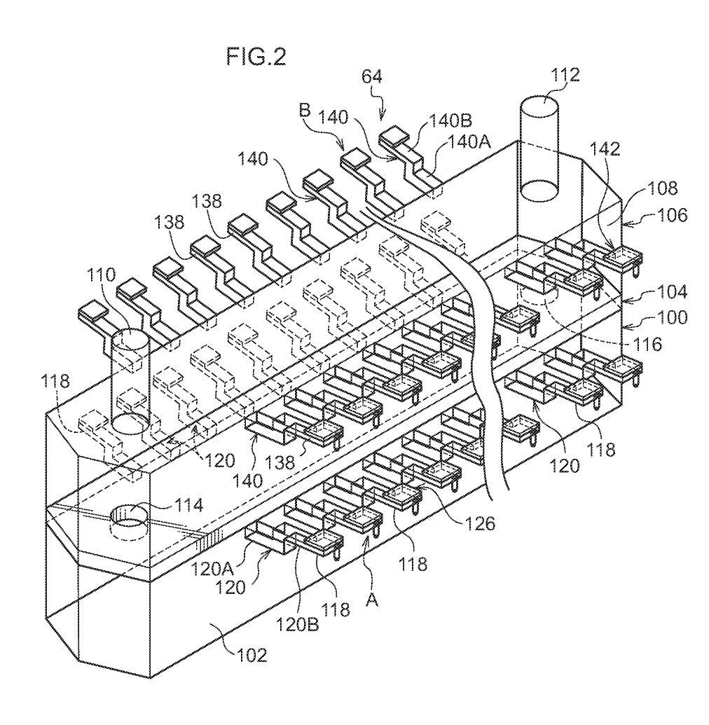

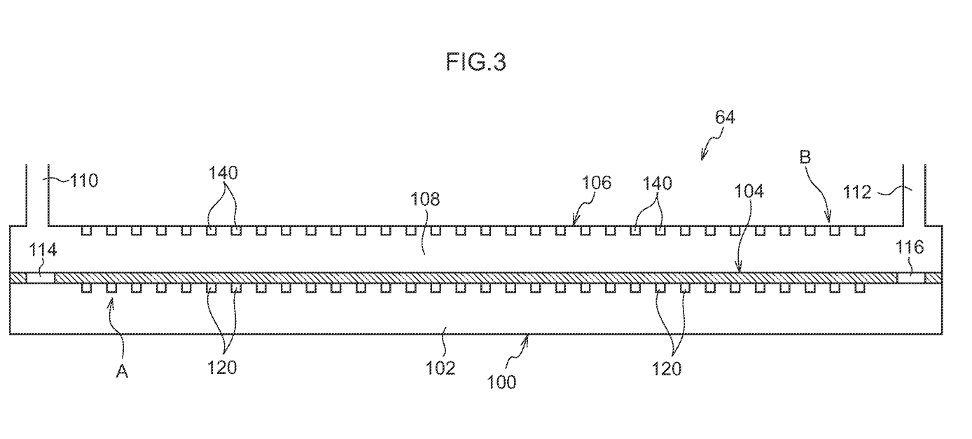

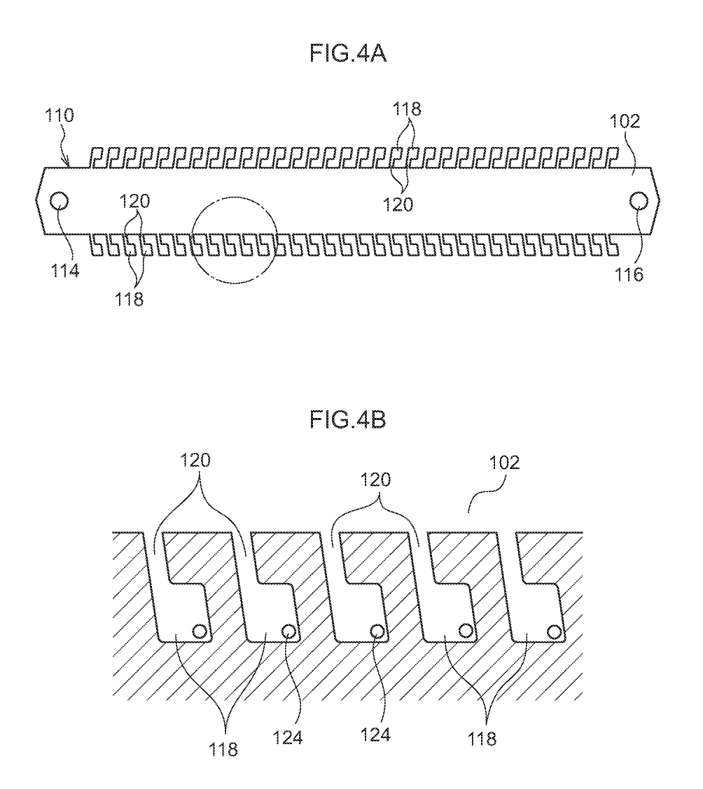

A see-through perspective view of a configuration of the inkjet line-head 64 is shown in FIG. 2. A cross-section of a configuration of the inkjet line-head 64 is shown in FIG. 3. As shown in these drawings, the inkjet line-head 64 is equipped with: a first common path plate 100 formed with a first common path 102 that is of an elongated shape and stores ink; a divider plate 104 joined to the top of the first common path plate 100; and a second common path plate 106 formed with a second common path 108 that is of an elongated shape and stores ink, the second common path 108 being joined to the top of the divider plate 104.

At the top of the second common path plate 106, at the two ends in the length direction thereof, an ink filling inlet 110 for supplying ink into the second common path 108, and an ink discharge outlet 112 for discharging ink from within the second common path 108, are respectively provided. The ink filling inlet 110 is connected to an ink tank (not shown in the drawings) in which ink is stored, and the ink discharge outlet 112 is connected to a discharge tank (not shown in the drawings) that collects ink. There are openings 114 and 116 provided respectively at each of the two ends of the divider plate 104, communicating the first common path 102 with the second common path 108.

Ink in the ink tank (not shown in the drawings) is supplied from the ink filling inlet 110 into the second common path 108. The ink in the second common path 108 is supplied to the first common path 102 via the opening 114, and the ink that has flowed along the length direction in the first common path 102 is supplied to the second common path 108 through the opening 116, and the ink flows along the length direction within the second common path 108. By so doing, the ink circulates between the first common path 102 and the second common path 108. The ink in the second common path 108 is discharged from the ink discharge outlet 112 into the discharge tank (not shown in the drawings).

The first common path 102 and the second common path 108 are formed of substantially the same length in the height direction, length in the length direction, and length in the width direction. Since the first common path 102 and the second common path 108 are disposed one above the other with the divider plate 104 therebetween, there is good placement efficiency, and the length in the length direction is set longer than the maximum width of the paper in order to realize a single-pass configuration.

At both sides along the length direction of the first common path plate 100, as shown in FIG. 2 and FIG. 5, are provided first pressure chambers 118 and plural first ink supply paths 120, serving as first liquid supply paths and respectively communicating with the first pressure chambers 118. The first ink supply paths 120 are formed in substantially an L-shape in a cross-section orthogonal to the length direction of the first common path 102 (a cross-section along the length direction of the first ink supply paths 120). A first end 120A of the first ink supply paths 120 is in communication with the top portion of the first common path 102. The first end 120A of the first ink supply paths 120 is disposed in a direction that is slightly inclined relative to the side wall face of the length direction of the first common path 102.

A second end 120B of the first ink supply paths 120 bends upwards and is in communication with the first pressure chambers 118. The plural first ink supply paths 120 extend out substantially parallel from the side walls of the first common path 102 (see FIG. 3). As they do so, the plural first ink supply paths 120 disposed on one side of the first common path 102 and the plural first ink supply paths 120 disposed on the other side of the first common path 102, are connected at positions in the length direction of the first common path 102 that do not align with each other. By so doing, the plural first pressure chambers 118 can be efficiently placed at position in the length direction that are staggered from each other. The ink in the first common path 102 is distributed to each of the first pressure chambers 118 through the respective first ink supply paths 120.

The first pressure chambers 118 are of a substantially square shaped plan form, with one of a pair of diametrically opposed corners thereof connected to the first ink supply paths 120 and the other of the pair in communication with the nozzles 122 through the flow outlets 124 provided. Note that the shape of the first pressure chambers 118 is not limited to the present example, with various figurations possible therefor, including plan forms of quadrangles (diamonds, rectangles or the like), pentagons, hexagons, other multi angled shapes, circular shapes, elliptical shapes or the like.

A first driving device 126 is provided, serving as a first driving section, to the top of each of the first pressure chambers 118. The first driving device 126 is equipped with a pressurizing plate (vibration plate that is also used as a common electrode) 128 configuring the top face of the first pressure chamber 118, a piezoelectric body 130 provided above the pressurizing plate 128, and an individual electrode 132 provided on the top face of the piezoelectric body 130. The piezoelectric body 130 deforms by application of a driving voltage between the individual electrode 132 and the common electrode, the volume of the first pressure chamber 118 changes, and ink is ejected from the nozzle 122 by an accompanying change in pressure. After ink has been ejected, new ink is refilled into the first pressure chamber 118, from the first common path 102 through the first ink supply path 120, when the displacement of the piezoelectric body 130 returns to its original position.

As shown in FIG. 2 and FIG. 5, plural second ink supply paths 140, serving as second liquid supply paths, are provided at both sides of the second common path plate 106 along the length direction thereof, and each is respectively in communication with a second pressure chamber 138. The second ink supply paths 140 are formed in substantially an L-shape in a cross-section orthogonal to the length direction of the second common path 108. A first end 140A of the second ink supply paths 140 is in communication with a top portion of the second common path 108. The first end 140A of the second ink supply paths 140 is disposed in a direction that is slightly inclined relative to the side wall face of the length direction of the second common path 108. A second end 140B of the second ink supply path 140 bends upwards and is in communication with the second pressure chamber 138. The plural second ink supply paths 140 on both sides of the second common path 108 are disposed in substantially the same positions as the plural first ink supply paths 120 on the two sides of the first common path 102, when viewed along the height direction. The ink in the second common path 108 is distributed to each of the second pressure chambers 138 through the respective second ink supply paths 140.

The second pressure chambers 138 are of substantially a square shape in plan shape, and are formed with the same dimensions as the first pressure chambers 118. The second ink supply paths 140 are connected to one of a pair of diametrically opposed corners of the second pressure chambers 138, and flow outlets 124 are provided to the other of the pair, communicating with nozzles 144.

A second driving device 142, serving as a second driving section, is provided above each of the second pressure chambers 138. The second driving device 142 is, in a similar manner to the first driving device 126, equipped with the pressurizing plate (vibration plate that is also used as a common electrode) 128, the piezoelectric body 130, and the individual electrode 132. The second driving device 142 drives the second pressure chamber 138 that is positioned such that the distance thereto from the first pressure chamber 118, driven by the first driving device 126, towards the first opening 114 and then through the second common path 108 is the same as the distance thereto from the first pressure chamber 118 toward the second opening 116 and then through the second common path 108. In other words, the second driving device 142 drives the second pressure chamber 138 that is positioned where the distances in the left and right directions from the first pressure chambers 118, driven by the first driving device 126, and doubling back through the opening 114 and the opening 116, respectively, are substantially the same as each other (the position where the distances in the first common path 102 and the second common path 108 clock-wise and anti-clockwise from the first pressure chambers 118 are substantially the same distances as each other). Configuration is made here with the second driving device 142 driving the second pressure chamber 138 with an opposite phase of driving voltage to that of the first driving device 126, generating a pressure wave that is of the opposite phase to the pressure wave generated by the pressure deflection of the first pressure chamber 118.

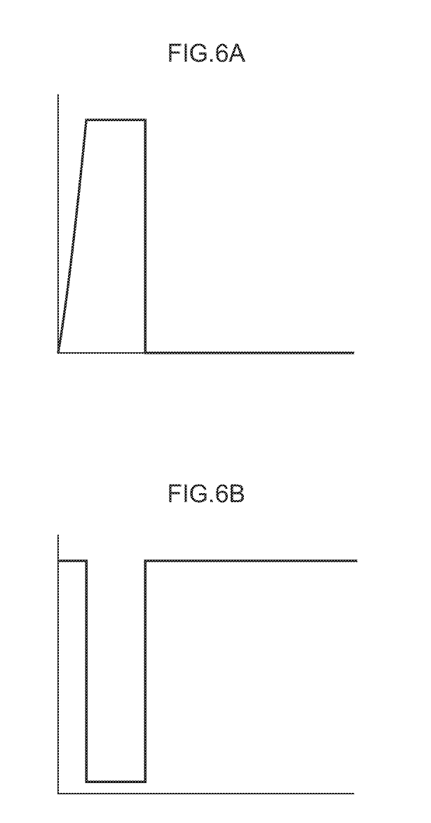

For example, as shown in FIG. 2 and FIG. 3, by driving the first pressure chamber 118 positioned at position A using the first driving device 126, when a square pressure wave is generated as shown in FIG. 6A, the second pressure chamber 138 positioned at position B, where the distance thereto from position A toward the first opening 114 and through the second common path 108 is the same as the distance thereto from position A toward the second opening 116 and through the second common path 108, is driven by the second driving device 142 to generate a pressure wave of opposite phase, as shown in FIG. 6B. Namely, when the pressure in the first pressure chamber 118 at position A is changed, the pressure wave that has been generated from the first pressure chamber 118, spreads out as a spherical wave in the first common path 102 from the outlet in the first ink supply path 120 communicating with the first pressure chamber 118. When this occurs, the spherical faced wave from the first pressure chamber 118 is attenuated by generating the pressure wave of opposite phase from the second pressure chamber 138 positioned at position B. When this occurs, since the second pressure chamber 138 is driven with a driving voltage that is of opposite phase to that of the first pressure chamber 118, ink is not ejected from the nozzle 144 in communication with the second pressure chamber 138.

When plural of the first pressure chambers 118 are driven and ink ejected therefrom, by driving plural of the second pressure chambers 138 that have the above positional relationships to the respective plural first pressure chambers 118, respective pressure waves of opposite phase to those of the plural first pressure chambers 118 are generated.

While not shown in the drawings, there are plural of the first common paths 102 and the second common paths 108 arrayed along a direction orthogonal to their length directions, and plural of the first pressure chambers 118 are provided at both sides of each of the respective first common paths 102 along the length direction, with the first ink supply paths 120 therebetween. A structure is thereby arrived at in which the plural first pressure chambers 118 are arrayed in a matrix shape corresponding to the nozzles 122.

Explanation will now be given of the operation and effect of the inkjet line-head 64 of the present exemplary embodiment.

Ink that has been supplied into the second common path 108 from the ink filling inlet 110 is supplied to the first common path 102 via the opening 114 of the divider plate 104. This ink flows along the length direction in the first common path 102 and is supplied to the second common path 108 through the opening 116 of the divider plate 104. Furthermore, the ink flows along the length direction in the second common path 108 and is supplied to the first common path 102 via the opening 114. The ink thereby circulates between the first common path 102 and the second common path 108.

The pressure of the first pressure chamber 118 is changed by application of a specific driving voltage between the individual electrode 132 of the respective first driving device 126 and the common electrode, and ink is ejected from the nozzle 122. When this occurs, the second driving device 142 drives the second pressure chamber 138 that is positioned where the distance thereto from the first pressure chamber 118 driven by the first driving device 126 toward the first opening 114 and through the second common path 108, is the same as the distance thereto toward the second opening 116 and through the second common path 108, with a driving voltage that is of the opposite phase to that of the first driving device 126. For example, as shown in FIG. 2 and FIG. 3, when a square shaped voltage wave, as shown in FIG. 6A, is generated by driving the first pressure chamber 118 at position A with the first driving device 126, a pressure wave is generated of opposite phase, as shown in FIG. 6B, by the second driving device 142 driving the second pressure chamber 138 positioned in position B.

When the pressure in the first pressure chamber 118 at position A is changed, the pressure wave that has been generated from the first pressure chamber 118 spreads out as a spherical faced wave in the first common path 102 from the outlet in the first ink supply path 120 communicating with the first pressure chamber 118. However, by generating a pressure wave of opposite phase from the second pressure chamber 138 at position B, the spherical faced wave from the first pressure chamber 118 can be attenuated, or cancelled out.

In the inkjet line-head 64 such as this, by provision of the second common path 108 in communication with the first common path 102 via the two end portions of the divider plate 104, the overall length of the common path becomes longer, and the path through which the ink circulates is made longer. In the present exemplary embodiment, since the first common path 102 and the second common path 108 have substantially the same dimensions, the overall length of the common path for storing the ink becomes twice that were only the first common path 102 to be provided. By so doing, since the resonance frequency of ink in the first common path 102 and the second common path 108 is lowered, the effective resonance frequency can be moved away from the ejection frequency band. For example, if the resonance frequency and the ejection frequency band would overlap in a configuration in which only the first common path 102 is provided, the resonance frequency can be made smaller than the ejection frequency band. Therefore, influence of cross-talk due to low frequency resonance can be suppressed. At the same time, since the circulation path for the ink is longer by provision of the first common path 102 and the second common path 108, effective attenuation can be made of the size of cross-talk due to viscosity attenuation.

Furthermore, the pressure wave propagating in the first common path 102 and the second common path 108 from the first pressure chamber 118 can be attenuated, or cancelled out, by the pressure wave of opposite phase generated from the second pressure chamber 138, and influence due to cross-talk can be reduced to substantially zero by dynamic damping.

By disposing the second common path 108 above the first common path 102, with the divider plate 104 interposed therebetween, and by communicating the first common path 102 and the second common path 108 at the two ends thereof, the first common path 102 and the second common path 108 can be placed with good efficiency, and a reduction in space is enabled. By circulating ink between the first common path 102 and the second common path 108, ink can be prevented, or suppressed, from dwelling in the first common path 102 and in the second common path 108.

### Second Exemplary Embodiment

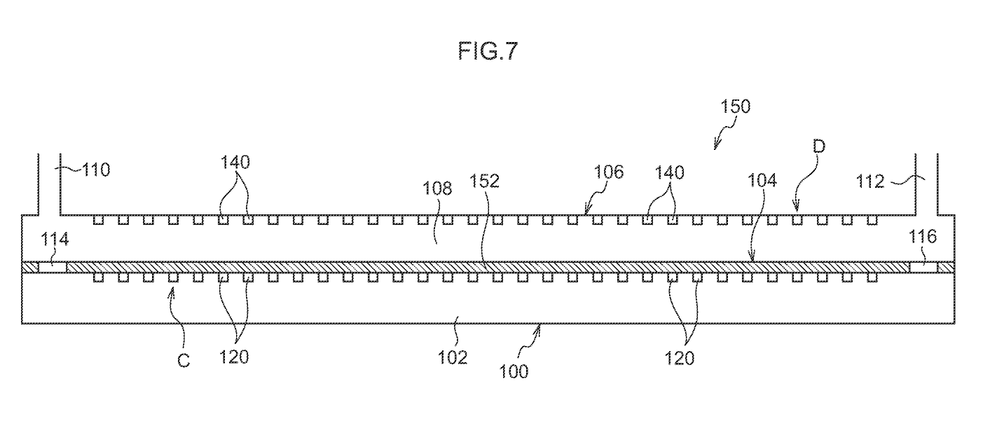

Explanation will now be given of an inkjet line-head as a recording head according to a second exemplary embodiment of the present invention, with reference to FIG. 7. Note that portions of the configuration that are similar to those of the previously described first exemplary embodiment are allocated the same reference numerals, and explanation thereof is omitted.

As shown in FIG. 7, in an inkjet line-head 150, a first pressure chamber 118 (see FIG. 2) is driven by a first driving device, and a second pressure chamber 138 that is positioned symmetrically opposite about a point, with respect to the center position 152 of the divider plate 104, is driven by a second driving device (see FIG. 2). For example, when the first pressure chamber 118 (see FIG. 2) at position C at one side face of the first common path 102, and in communication with the first ink supply path 120, is driven, the second pressure chamber 138 (see FIG. 2) in communication with the second ink supply path 140 at position D, symmetrically opposite with respect to a point (on the opposite side face to position C), with respect to the center position 152 of the divider plate 104, is driven. Since there is point symmetry about the center position 152 of the divider plate 104, the side face of the second common path 108 to which the second ink supply path 140 at position D is connected, is the opposite side face to the side face of the first common path 102 to which the first ink supply path 120 at position C is connected.

In a similar manner to in the first exemplary embodiment, when a pressure wave is generated from the first pressure chamber 118 at position C, a pressure wave of opposite phase is generated from the second pressure chamber 138 at position D. By so doing, the pressure wave that propagates in the first common path 102 and the second common path 108 from the first pressure chamber 118 can be attenuated, or cancelled out.

Supplementary Explanation

The positional relationships and the driving voltages between the symmetrically driven first pressure chamber 118 and second pressure chamber 138 are not limited to those of the first exemplary embodiment and the second exemplary embodiment, and other configurations may be made. For example, configuration may be made such that the second pressure chamber 138, at a specific position with respect to the first pressure chamber 118 that has been driven by the first driving device 126, is driven by the second driving device 142 with a specific driving voltage set in advance so as to be capable of attenuating the pressure wave from the first pressure chamber 118. By so doing, the pressure wave that propagates out in the first common path 102 and the second common path 108 from the first pressure chamber 118 can be attenuated by the pressure wave from the second pressure chamber 138.

In the inkjet line-head 64 of the first exemplary embodiment, the nozzle 144 is provided in communication with the second pressure chamber 138, however since there is no necessity to eject ink from the second pressure chamber 138, a configuration may be made with no nozzles provided in communication with the second pressure chamber 138.

What is claimed is:

1. A recording head comprising:
a first common path that stores a liquid;
a second common path that is disposed along a length direction of the first common path, with the liquid circulated between the first common path and the second common path through a first opening and a second opening formed respectively in the two ends of a divider plate that divides the second common path from the first common path;
a plurality of first pressure chambers that are respectively in communication with a plurality of first liquid supply paths connected to the first common path, with the first pressure chambers filled by the liquid supplied through the respective first liquid supply path from the first common path;
a plurality of first driving sections that change pressure of the respective first pressure chambers, and eject liquid droplets from a nozzle communicating with the respective first pressure chamber toward a recording medium;
a plurality of second pressure chambers that are respectively in communication with a plurality of second liquid supply paths connected to the second common path, with the second pressure chambers filled by the liquid supplied through the respective second liquid supply path from the second common path;
a plurality of second driving sections that change pressure of one or other of the second pressure chambers, and generate a pressure wave that attenuates a pressure wave from the first pressure chamber that was driven by the first driving section, propagating in the first common path and the second common path, the pressure wave not ejecting liquid droplets.

2. The recording head of claim 1, wherein:
the first common path and the second common path are formed with the same dimensions; and
the second pressure chamber that is driven by the second driving section is the second pressure chamber positioned where the distance thereto from the first pressure chamber driven by the first driving section toward the first opening and through the second common path is the same as the distance thereto from the first pressure chamber toward the second opening and through the second common path, and a pressure wave is generated that is of opposite phase to that of the pressure wave generated from the first pressure chamber.

3. The recording head of claim 1, wherein:
the first common path and the second common path are formed with the same dimensions; and
the second pressure chamber that is driven by the second driving section is positioned symmetrically about a point with respect to the first pressure chamber that is driven by the first driving section, relative to a central position of the divider plate.

4. The recording head of claim 1, wherein the second pressure chamber is not provided with a nozzle for ejecting liquid droplets.

5. An image forming apparatus that forms an image by passing a recording medium through a position facing a recording head, the image forming apparatus comprising:
the recording head of claim 1; and
a conveying section that conveys a recording medium to a position facing the recording head.

6. The recording head of claim 1, wherein the first common path and the second common path are formed of substantially the same length in the height direction, length in the length direction, and length in the width direction.

7. The recording head of claim 1, wherein the first common path and the second common path are disposed one above the other with the divider plate therebetween, and the length in the length direction is set longer than the maximum width of the paper.

8. The recording head of claim 1, wherein the first ink supply paths are formed in substantially an L-shape in a cross-section orthogonal to the length direction of the first common path, and a first end of the first ink supply paths is in communication with the top portion of the first common path.

9. The recording head of claim 1, wherein the first end of the first ink supply paths is disposed in a direction that is inclined relative to the side wall face of the length direction of the first common path.

10. The recording head of claim 1, wherein the plural first ink supply paths disposed on one side of the first common path and the plural first ink supply paths disposed on the other side of the first common path, are connected at positions in the length direction of the first common path that do not align with each other.

11. The recording head of claim 1, wherein the second ink supply paths are formed in substantially an L-shape in a cross-section orthogonal to the length direction of the second common path, and a first end of the second ink supply paths is in communication with a top portion of the second common path.

12. The recording head of claim 1, wherein the first end of the second ink supply paths is disposed in a direction that is slightly inclined relative to the side wall face of the length direction of the second common path.

13. The recording head of claim 1, wherein a second end of the second ink supply path bends upwards and is in communication with the second pressure chamber.

14. The recording head of claim 1, wherein the plural second ink supply paths on both sides of the second common path are disposed in substantially the same positions as the plural first ink supply paths on the two sides of the first common path, when viewed along the height direction.
